(19) United States
(12) Patent Application Publication
(10) Pub. No.: US 2026/0067157 A1
(43) Pub. Date: Mar. 5, 2026

(54) CONFIGURATION INPUT APPARATUS, CONFIGURATION INPUT METHOD, AND CONFIGURATION INPUT PROGRAM

(71) Applicant: NIPPON TELEGRAPH AND TELEPHONE CORPORATION, Tokyo (JP)

(72) Inventors: Hiroki IWAHASHI, Tokyo (JP); Masato NISHIGUCHI, Tokyo (JP); Hiroki INOUE, Tokyo (JP); Toshiyuki KANAZAWA, Tokyo (JP)

(73) Assignee: NIPPON TELEGRAPH AND TELEPHONE CORPORATION, Tokyo (JP)

(21) Appl. No.: 19/105,075

(22) PCT Filed: Aug. 22, 2022
(86) PCT No.: PCT/JP2022/031635

§ 371 Date: Feb. 20, 2025

(51) Int. Cl. H04L 41/0806; H04L 41/0873

(52) U.S. Cl. CPC H04L 41/0806; H04L 41/0873

(57) ABSTRACT

A centralized management server includes a device control unit. The device control unit acquires a plurality of configuration input requests corresponding to a specific communication device. Thereafter, the device control unit determines whether the plurality of configuration input requests conflict with other configuration input requests corresponding to the specific communication device. In a case where it is determined that the plurality of configuration input requests do not conflict with the other configuration input requests, the device control unit collectively inputs a plurality of configurations corresponding to the plurality of configuration input requests to the specific communication device.

### TECHNICAL FIELD

The present disclosure relates to a configuration input device, a configuration input method, and a configuration input program.

### BACKGROUND ART

Communication carriers provide various kinds of communication services. Examples of the communication services include an Internet connection service and a video distribution service. These communication services are provided according to a “user configuration” configured in a communication device such as an edge router.

For convenience, the configuration is abbreviated as a configuration (config). For example, a user config means a user configuration.

The user configuration includes data such as a user identifier (ID) and a service to be used by a user. The user configuration is set by a centralized management server.

The centralized management server manages resources of communication devices constituting a network. For example, the resources of the communication devices include a bandwidth, the number of filters that can be set in the communication devices, and the number of sessions that can be established. Data about the resources is collected in the centralized management server. The centralized management server selects a communication device that is to accommodate the user according to free resources of the respective communication devices. Thereafter, the centralized management server sets the user configuration in the selected communication device.

The centralized management server includes a plurality of functional units. In order to process control for a large number of devices at high speed, the plurality of functional units include a plurality of device control units. Each device control unit accesses the communication device according to content of orders and then executes a control command. Hereinafter, the “orders” may be referred to as “requests”.

### CITATION LIST

### Patent Literature

Patent Literature 1: WO 2021/044604 A
Patent Literature 2: WO 2022/003926 A
Patent Literature 3: WO 2022/044341 A

### Non Patent Literature

Non Patent Literature 1: Hiroki Iwahashi, and three other persons, “Ansible ni yoru kaizou youi na edge router eno user configu tounyu (in Japanese) (Input of User Configuration to Edge Router That Is Easily Modified by Ansible)” 2021 IEICE General Conference Lecture Proceedings, B-6-67, Mar. 11, 2021
Non Patent Literature 2: Hiroki Iwahashi, and four other persons, “User shuyou jyunanka system ni okeru shuyou kirikaesaki seigen houhou no kentou (in Japanese) (Study on Method for Restricting Accommodation Destination in User Accommodation Flexibility System”, The Institute of Electronics, Information and Communication Engineers 2021 Society Convention, B-6-11, Sep. 14, 2021
Non Patent Literature 3: Hiroki Iwahashi, and three other persons, “Edge router config tounyu server no kaizou youina youkyu uketsuke kinou (in Japanese) (Easily Modified Request Acceptance Function of Edge Router Config Input Server)”, The Institute of Electronics, Information and Communication Engineers 2022 general meeting, B-6-33, Mar. 15, 2022

### SUMMARY OF INVENTION

### Technical Problem

However, in the above-described prior art, it may be difficult to improve performance in processing of configuration input requests.

Thus, the present disclosure provides a configuration input device, a configuration input method, and a configuration input program capable of improving performance in processing of configuration input requests.

### Solution to Problem

In one aspect of the present disclosure, a configuration input device includes an acquisition unit that acquires a plurality of configuration input requests corresponding to a specific communication device, a conflict determination unit that determines whether the plurality of configuration input requests conflict with other configuration input requests corresponding to the specific communication device, and an inputting unit that collectively inputs a plurality of configurations corresponding to the plurality of configuration input requests to the specific communication device in a case where it is determined that the plurality of configuration input requests do not conflict with the other configuration input requests.

### Advantageous Effects of Invention

A configuration input device can improve performance in processing of configuration input requests.

### BRIEF DESCRIPTION OF DRAWINGS

FIG. 1A illustrates an example of processing for inputting a configuration to a communication device.

FIG. 1B illustrates an example of processing for inputting a configuration to the communication device.

FIG. 2 illustrates an example of exclusive control for the communication device.

FIG. 3 illustrates an example of resource control for the communication device.

FIG. 4 illustrates an example of problems related to exclusive control.

FIG. 5 illustrates an example of problems related to resource control.

FIG. 6 is a block diagram of an example of an environment for configuration input.

FIG. 7 is a block diagram of an example of a configuration of a centralized management server according to the present disclosure.

FIG. 8 illustrates an example of configuration input processing according to the present disclosure.

FIG. 9 is a flowchart indicating an example of processing for inputting a configuration to the communication device.

FIG. 10 is a flowchart indicating an example of processing for establishing resource control for the communication device.

FIG. 11 illustrates an example of a hardware configuration of a computer.

### DESCRIPTION OF EMBODIMENTS

A plurality of embodiments of the present disclosure are set forth in the accompanying drawings and the following description. Note that the present invention is not limited to these embodiments. Various features of these embodiments may be combined in various ways, provided that these features do not contradict each other. Like reference numerals indicate like elements.

The following description includes nine sections: Outline
1. Introduction
   1-1. Configuration Input Processing
   1-2. Exclusive Control-Avoidance of Conflict of Configuration Input Requests
   1-3. Resource Control-Arrangement of Resources of Centralized Management Server
   1-4. Examples of Problems
2. Environment for Configuration Input
3. Configuration of Centralized Management Server
4. Configuration Input Processing According to Present Disclosure
   4-1. Batch Input of Configurations
   4-2. Resource Control to Avoid Expected Delay
   5. Flowchart of Configuration Input Processing
6. Effects
7. Hardware Configuration
8. Summary of embodiments
9. Supplements

### [Outline]

Outline of the technique according to the present disclosure will be described in the section of outline. This outline is not intended to limit the present invention or a plurality of embodiments to be described in the following sections.

Various techniques have been proposed for efficiently inputting a user configuration to a communication device. The user configuration is input from a centralized management server to the communication device. The centralized management server includes a plurality of components such as a configuration input request management database (management DB), a resource controller, and a plurality of device control units.

For example, in one configuration input technique, the device control unit performs the following operation: (1) acquire a configuration input request (configuration input order) from the management DB; and (2) input a configuration to the communication device. On the other hand, the resource controller performs the following operation: (1) allocate a resource to the device control unit according to the number of configuration input requests; (2) perform scale-up (temporary addition of the device control unit); and (3) change a frequency at which the device control unit confirms an order (configuration input request) to the management DB.

However, a large number of orders of configuration input may be concentrated on the same communication device. In this case, processing periods of the orders may be lengthened by exclusive control. In addition, a large number of orders may be evenly distributed to all the communication devices. In this case, configuration input may be delayed in some communication devices. This is because one control device inputs configurations to a plurality of communication devices. For example, if the number of communication devices controlled by the control device exceeds the number of communication devices that can be simultaneously controlled by the control device, configuration input is delayed.

Thus, in the technique according to the present disclosure, the device control unit collectively acquires a plurality of orders to the same communication device when the device control unit acquires the orders from the management DB. Furthermore, the device control unit performs conflict determination of a plurality of orders and then collectively inputs a plurality of orders that do not conflict with each other to the same communication device.

On the other hand, the resource controller monitors types of the orders and a target communication device. In a case where delays of the orders are predicted, the resource controller determines whether the orders are distributed to all the communication devices. In a case where the orders are distributed to all the communication devices, the resource controller adds the device control unit.

Further, the resource controller determines whether the orders are concentrated on a specific communication device. In a case where orders are concentrated on a specific communication device, the resource controller changes setting of the device control unit such that the device control unit controls only the specific communication device.

As a result, the technique according to the present disclosure can reduce a frequency at which the device control unit confirms the management DB. As described above, a large number of orders of configuration input may be concentrated on the same communication device. In addition, a large number of orders may be evenly distributed to all the communication devices. Even in such a situation, the technique according to the present disclosure can reduce delay in configuration input.

### 1. INTRODUCTION

Various types of communication services are provided through an Internet protocol (IP) network. The IP network includes a plurality of communication devices such as edge routers.

The plurality of communication devices stores user configurations. Each communication device performs various communication control on the basis of configuration information set for each user. For example, the configuration information includes information related to a communication service such as an Internet connection service and a video distribution service.

The user configuration is managed by the centralized management server connected to the IP network. The centralized management server receives a configuration input request from a host system. The host system is, for example, a communication control system managed by a communication carrier. The host system may be an operator.

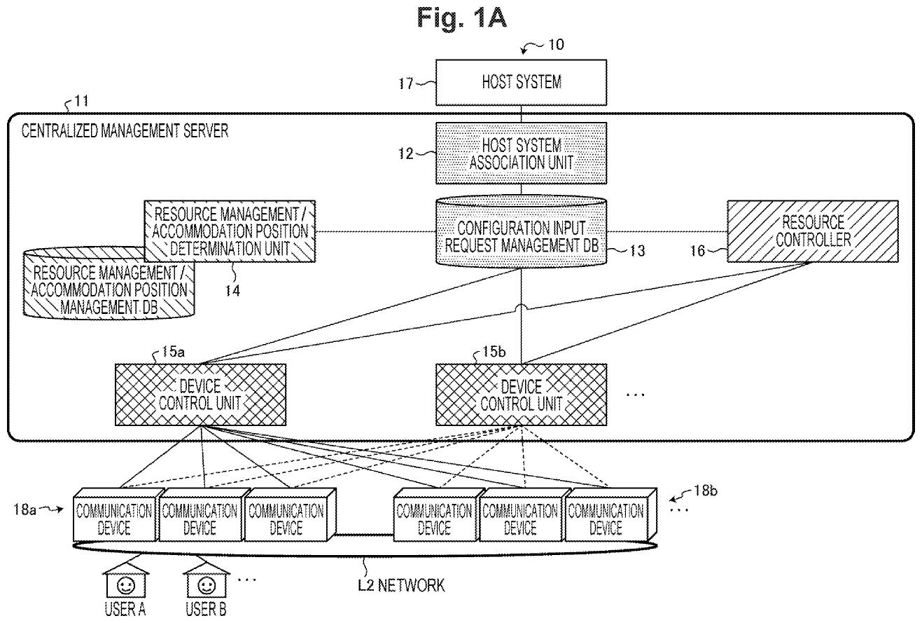

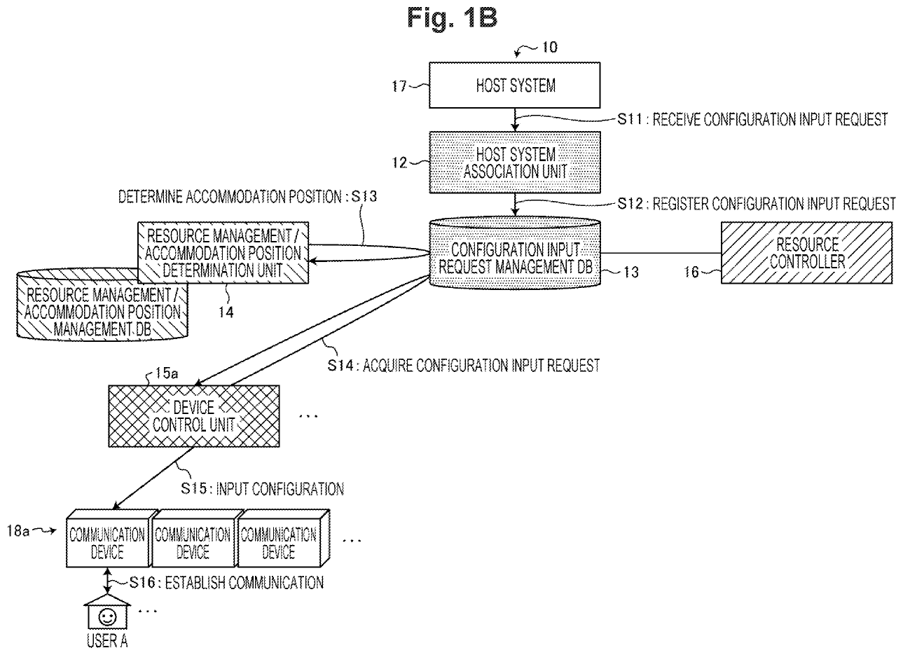

The centralized management server inputs a configuration to the communication device on the basis of the configuration input request. An example of processing for inputting a configuration into the communication device will be described in the following sections with reference to FIGS. 1A and 1B.

### 1-1. Configuration Input Processing

FIGS. 1A and 1B collectively illustrate processing 10 that is an example of processing for inputting a configuration to the communication device.

The processing 10 is performed by a centralized management server 11. As illustrated in FIG. 1A, the centralized management server 11 includes a host system association unit 12, a configuration input request management database (DB) 13, a resource management/accommodation position determination unit 14, a plurality of device control units 15, and a resource controller 16. The resource management/accommodation position determination unit 14 includes a resource management/accommodation position management DB.

As illustrated in FIG. 1B, the processing 10 includes six steps from step S11 to step S16.

In step S11, the centralized management server 11 receives a configuration input request from the host system 17. The configuration input request is, for example, a request for inputting a configuration of a new user.

In step S12, the host system association unit 12 registers the configuration input request in the configuration input request management DB 13.

In step S13, the resource management/accommodation position determination unit 14 determines an accommodation position of the user.

For example, the resource management/accommodation position determination unit 14 periodically monitors the configuration input request management DB 13. In addition, the resource management/accommodation position determination unit 14 manages an amount of free resources of each communication device 18. In a case where a new configuration input request is registered in the configuration input request management DB 13, the resource management/accommodation position determination unit 14 refers to the resource management/accommodation position management DB. The resource management/accommodation position determination unit 14 confirms a free accommodation position.

After confirming the free accommodation position, the resource management/accommodation position determination unit 14 appropriately determines the communication device 18 and a link aggregation (LAG) (or physical port) that are to accommodate the user according to the amount of free resources of each communication device 18. For example, the communication device 18 that is to accommodate the user is determined from an edge router group (edge group) with which the user can communicate. In the example of FIG. 1B, a communication device 18a is determined as the communication device that is to accommodate a user A.

In step S14, a device control unit 15a acquires a configuration input request from the configuration input request management DB 13. In order to acquire a new configuration input request, the device control unit 15a periodically monitors the configuration input request management DB 13.

In step S15, the device control unit 15a inputs the configuration to the communication device determined as an accommodation destination by the resource management/accommodation position determination unit 14. In the example of FIG. 1B, the communication device determined as the accommodation destination is the communication device 18a. The device control unit 15a inputs the configuration of the user A to the communication device 18a.

In step S16, the device control unit 15a establishes communication. In the example of FIG. 1B, communication of the user A is established on the communication device 18a to which the configuration is input.

### 1-2. Exclusive Control-Avoidance of Conflict of Configuration Input Requests

If a plurality of device control units 15 simultaneously access the communication device 18 and then execute control commands or input configurations, there is a possibility that a conflict may occur. Thus, the centralized management server 11 requires exclusive control in order to avoid a conflict.

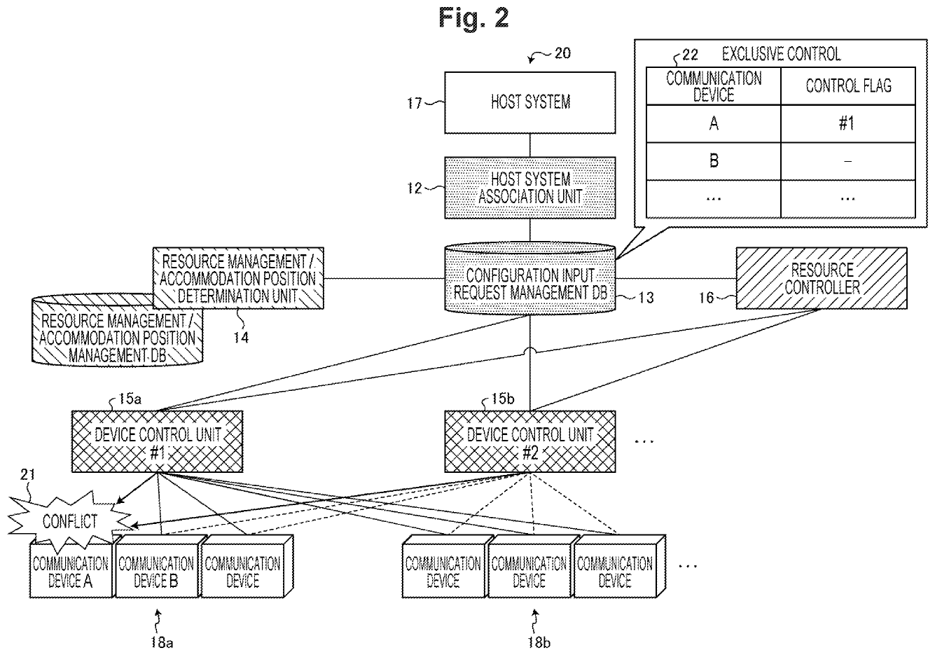

FIG. 2 illustrates exclusive control 20 which is an example of exclusive control for the communication devices.

In the example of FIG. 2, the device control unit 15a (device control unit #1) and a device control unit 15b (device control unit #2) simultaneously access the communication device 18a (communication device A). These device control units execute control commands and input configurations. Such operation may cause a conflict 21. In order to avoid a conflict, exclusive control is performed in the device control units 15.

As illustrated in FIG. 2, a table 22 for management of exclusive control is prepared in the configuration input request management DB 13. The table 22 manages a flag of exclusive control. The flag limits the plurality of device control units 15 capable of simultaneously controlling the specific communication device 18 to one device control unit 15.

In the example of FIG. 2, the communication device A is associated with a control flag #1. In this case, the device control unit 15a (device control unit #1) can control the communication device A, but the other device control unit 15 cannot control the communication device A.

### 1-3. Resource Control—Arrangement of Resources of Centralized Management Server

The resource controller 16 monitors an operation state of each functional unit. The resource controller 16 controls operation of each functional unit according to a resource state of each functional unit.

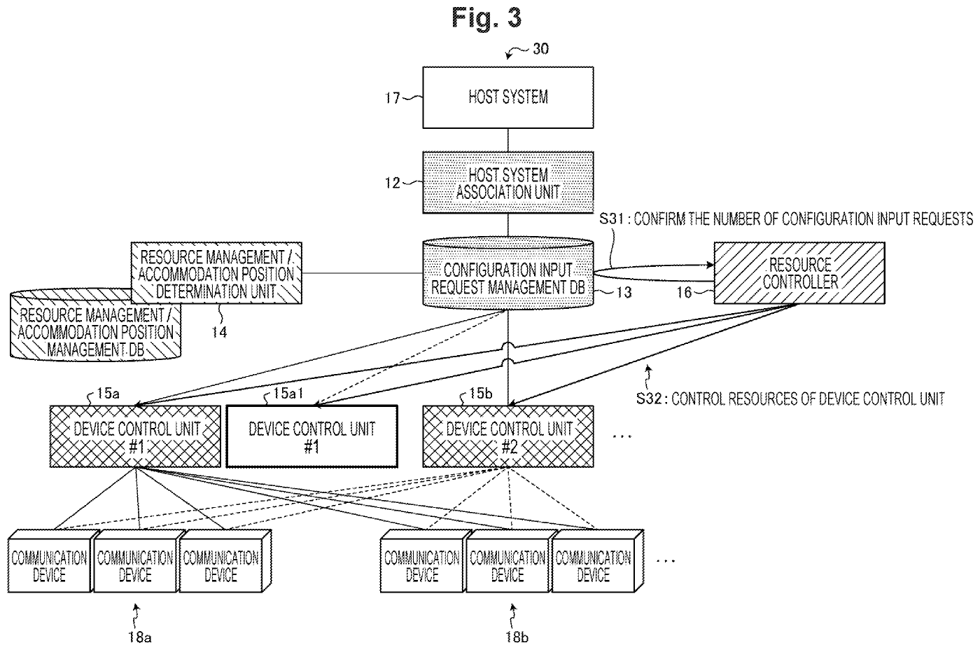

FIG. 3 illustrates resource control 30 which is an example of resource control for the communication device.

As illustrated in FIG. 3, the resource control 30 includes step S31 and step S32.

In step S31, the resource controller 16 confirms the number of configuration input requests waiting for processing. The resource controller 16 monitors the number of received configuration input requests at regular time intervals.

In step S32, resources of the device control unit 15 are controlled. The resource controller 16 allocates resources to the device control unit 15 according to the number of confirmed requests. In order to prevent accumulation of the input requests, the resource controller 16 temporarily adds a device control unit 15a1 to the device control unit 15a, for example. Alternatively, the resource controller 16 may allocate compute resources to the device control unit 15a. In addition, the resource controller 16 can change a frequency at which the device control unit 15 confirms the configuration input request management DB 13.

Note that DB access resources may be depleted due to all the device control units 15 too frequently accessing the DB. In order to prevent such a situation, the resource control in step S32 may be applied only to the device control unit 15 that requires resource expansion and acceleration of a confirmation frequency. Thus, the overall resource amount of the centralized management server 11 can be suppressed even at the peak time.

### 1-4. Example of Problems

Order processing performance of the centralized management server 11 may be reduced for reasons described below. Further, if a large number of orders flow in a burst manner, the orders may not be processed. If the order exceeds a timeout period of the order, the order is treated as an error.

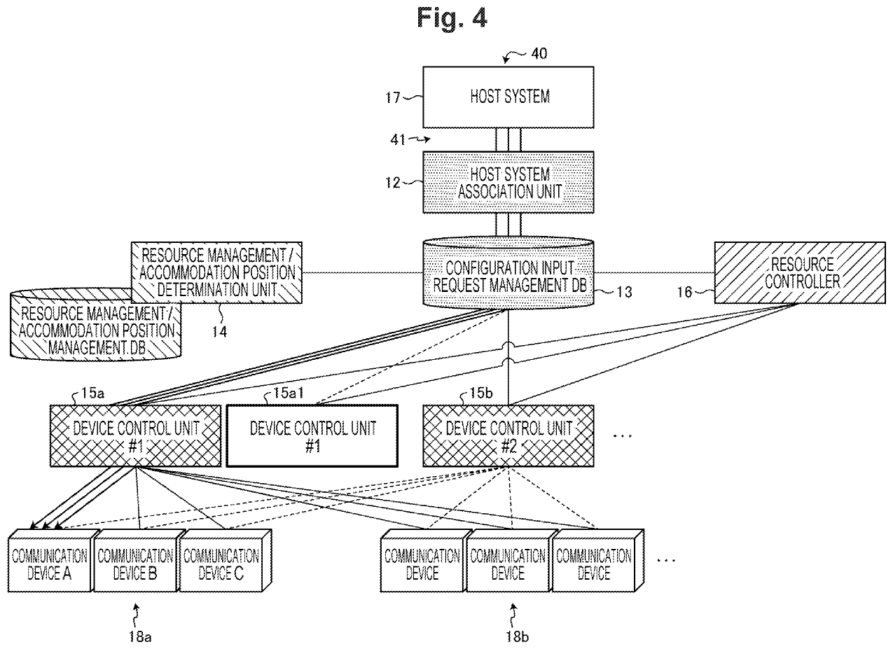

FIG. 4 illustrates a problem 40 which is an example of problems related to exclusive control.

As described above with reference to FIG. 2, if a plurality of device control units 15 simultaneously access the same communication device 18 and then execute commands, a command conflict may occur. The command conflict can cause unexpected behavior. Thus, the centralized management server 11 requires exclusive control for the communication device 18 to be controlled. However, due to an exclusive control mechanism, a waiting period occurs when the commands are input to the same communication device 18. As a result, an order processing period becomes long.

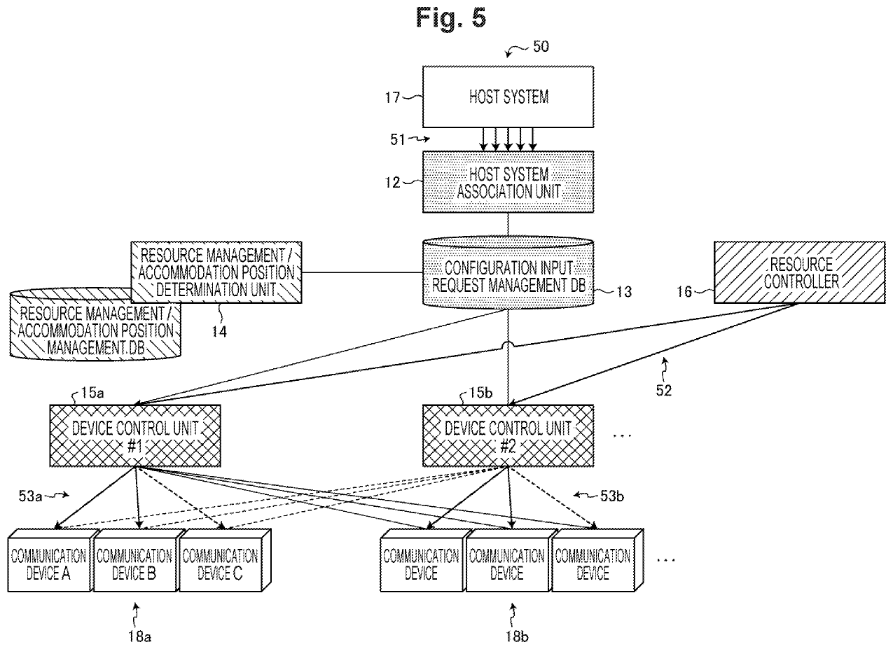

For exclusive control, the orders are in principle processed one by one. Thus, processing waiting periods become long for the orders input to the same communication device 18. The orders are processed by the individual device control units 15 or the communication devices 18. As described below with reference to FIG. 5, the processing waiting period becomes a problem in a case where the processing period of each order is long.

Even if the resource controller 16 performs scale-out of the device control unit 15 or additionally allocates resources to the device control unit 15, performance of the order processing may not be improved.

The resource controller 16 performs scale-out of the device control unit 15 on the basis of the number of orders input from the host system 17. This scale-out is performed to improve performance of the order processing. However, the performance of the order processing is not improved by scale-out with respect to orders input to the same communication device 18. This is because only the specific device control unit 15 inputs orders to the device control unit 15 for exclusive control. Determination as to whether resource control is effective requires consideration of the number of communication devices 18 that can be simultaneously controlled by one device control unit 15, a degree of concentration of orders on the same communication device 18, and the like.

In the example of FIG. 4, a large number of orders are concentrated on the communication device A (41). Even if a large number of orders are concentrated on a specific communication device 18, only the specific device control unit 15 inputs the orders to the device control unit 15. As a result, other device control units 15 that have enough power are left. In this case, it is meaningless to simply add the device control unit 15a1.

FIG. 5 illustrates a problem 50 which is an example of problems related to resource control.

In the example of FIG. 5, a large number of orders are evenly distributed to all the communication devices 18 (51). The resource controller 16 additionally allocates resources to the device control unit 15a and the device control unit 15b (52). The additional resources improve processing speed of the device control unit 15a and the device control unit 15b.

One device control unit can control a plurality of communication devices 18. However, in a case where a large number of orders are evenly distributed to all the communication devices 18 in a situation where one device control unit controls many communication devices 18, input of the orders to some of the communication devices 18 is delayed (53a, 53b). Even if the resource controller 16 allocates resources to the device control unit 15 to improve processing speed of the device control unit 15, improvement of the processing speed is less effective in preventing delay of order input.

Examples of other problems include processing speed of the device control unit 15. The processing of the device control unit 15 may be slow in the first place.

The device control unit 15 executes command generation/input according to the order. The command generation/input includes steps such as activation of a command generation function, command generation processing, establishment of connection with the communication device 18 (edge router), command input, response waiting, and response check (check of input result).

The activation of the command generation function and the command generation processing may take time depending on an implementation scheme or use software. For example, an external system may be incorporated in the centralized management server 11. The establishment of the connection, the command input, and the response check may take time depending on an implementation scheme of a command conversion unit of the device control unit 15, use software, or the communication device 18.

In order to solve the above problem, the centralized management server according to the present disclosure performs one or more kinds of configuration input processing which will be described below.

### 2. ENVIRONMENT FOR CONFIGURATION INPUT

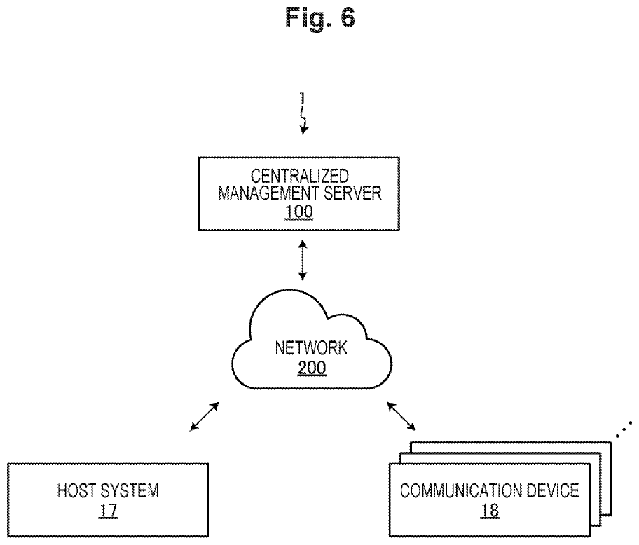

First, an environment for configuration input will be described with reference to FIG. 6.

FIG. 6 is a block diagram of an environment 1 which is an example of the environment for configuration input. As illustrated in FIG. 6, the environment 1 includes a centralized management server 100, a network 200, a host system 17, and a plurality of communication devices 18. The centralized management server 100 is an example of a configuration input device.

The environment 1 can include a plurality of centralized management servers 100. The plurality of centralized management servers 100 can constitute a system for configuration input.

The centralized management server 100 is a device that performs processing for inputting a configuration. In this specification, such processing is referred to as configuration input processing. Various kinds of configuration input processing will be described in detail in section 4.

The centralized management server 100 is a computer such as a server. An example of a configuration of the centralized management server 100 will be described in section 4.

The network 200 is a network such as a local area network (LAN), a wide area network (WAN) and the Internet. The network 200 connects the centralized management server 100, the host system 17, and the plurality of communication devices 18.

### 3. CONFIGURATION OF CENTRALIZED MANAGEMENT SERVER

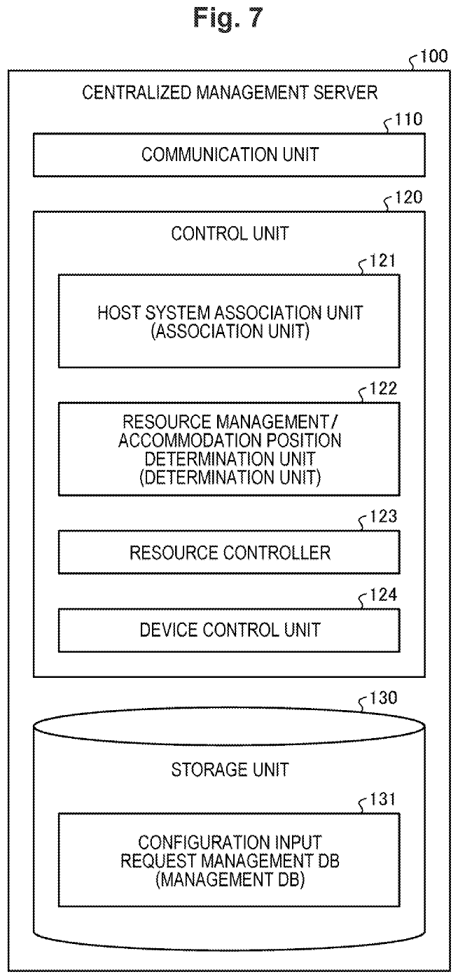

Next, an example of the configuration of the centralized management server 100 will be described with reference to FIG. 7.

FIG. 7 is a block diagram of an example of the configuration of the centralized management server 100 according to the present disclosure. As illustrated in FIG. 7, the centralized management server 100 includes a communication unit 110, a control unit 120, and a storage unit 130. The centralized management server 100 may include an input unit (for example, a keyboard or a mouse) that receives an input from an administrator of the centralized management server 100. In addition, the centralized management server 100 may include an output unit (for example, a liquid crystal display or an organic electro luminescence (EL) display) that displays information to the administrator.

### (Communication Unit 110)

The communication unit 110 is implemented by a network device such as a network interface card (NIC). The communication unit 110 is connected to the network 200 in a wired or wireless manner. The communication unit 110 can transmit and receive data to and from the host system 17 and the plurality of communication devices 18 via the network 200.

### (Control Unit 120)

The control unit 120 is implemented by a data processing device and various programs stored in a storage device. The data processing device is, for example, a processor such as a central processing unit (CPU), a micro processing unit (MPU) and a general purpose graphic processing unit (GPGPU). The control unit 120 may be implemented as a controller for controlling a plurality of kinds of operation of the centralized management server 100. For example, in a case where one or more processors execute programs (a plurality of instructions) by using a random access memory (RAM) as a work area, the one or more processors perform a plurality of kinds of operation.

The control unit 120 can receive input data for configuration input processing from an external device. The control unit 120 can store data such as input data, data to be used in configuration input processing, and output data of the configuration input processing in the storage unit 130. The control unit 120 can acquire such data from the storage unit 130 as necessary.

### (Storage Unit 130)

The storage unit 130 is implemented by a semiconductor memory such as a RAM and a flash memory, a magnetic disk such as a hard disk, or an optical disk. The storage unit 130 can store various programs and various kinds of data.

As illustrated in FIG. 7, the control unit 120 includes a host system association unit 121, a resource management/accommodation position determination unit 122, a resource controller 123, and a device control unit 124. The storage unit 130 includes a configuration input request management DB. For convenience, hereinafter, the “host system association unit”, the “resource management/accommodation position determination unit”, and the “configuration input request management DB” will be referred to as an “association unit”, a “determination unit”, and a “management DB”, respectively, for short.

The resource controller 123 is an example of a distribution determination unit, a scale-out unit, a concentration determination unit, and a scale-up unit. The device control unit 124 is an example of an acquisition unit, a conflict determination unit, an inputting unit, a storing unit, and an addition unit.

Data processing to be performed by individual units will be described below. In addition, DBs to be accessed by individual units will be described below.

### (Association Unit 121)

The association unit 121 receives a request (order) to input the user configuration to the communication device. This request is referred to as a configuration input request.

### (Determination Unit 122)

The determination unit 122 determines the communication device 18 that is to accommodate the user on the basis of information regarding the order of the host system 17 and information regarding the user.

### (Resource Controller 123)

The resource controller 123 may have functions similar to those of the resource controller 16 described above with reference to FIGS. 1A, 1B, 2, 3, 4 and 5. Description of the functions that is the same as that of the resource controller 16 is omitted here.

### (Device Control Unit 124)

The device control unit 124 may have functions similar to those of the device control unit 15 described above with reference to FIGS. 1A, 1B, 2, 3, 4, and 5. Description of the functions that is the same as that of the device control unit 15 is omitted here.

### (Management DB 131)

The management DB 131 may have functions similar to those of the configuration input request management DB 13 described above with reference to FIGS. 1A, 1B, 2, 3, 4, and 5. Description of the functions that is the same as that of the configuration input request management DB 13 is omitted here.

### 4. CONFIGURATION INPUT PROCESSING ACCORDING TO PRESENT DISCLOSURE

Various kinds of configuration input processing will be described in detail in this section. A mechanism described below improves performance of request processing of the centralized management server 100.

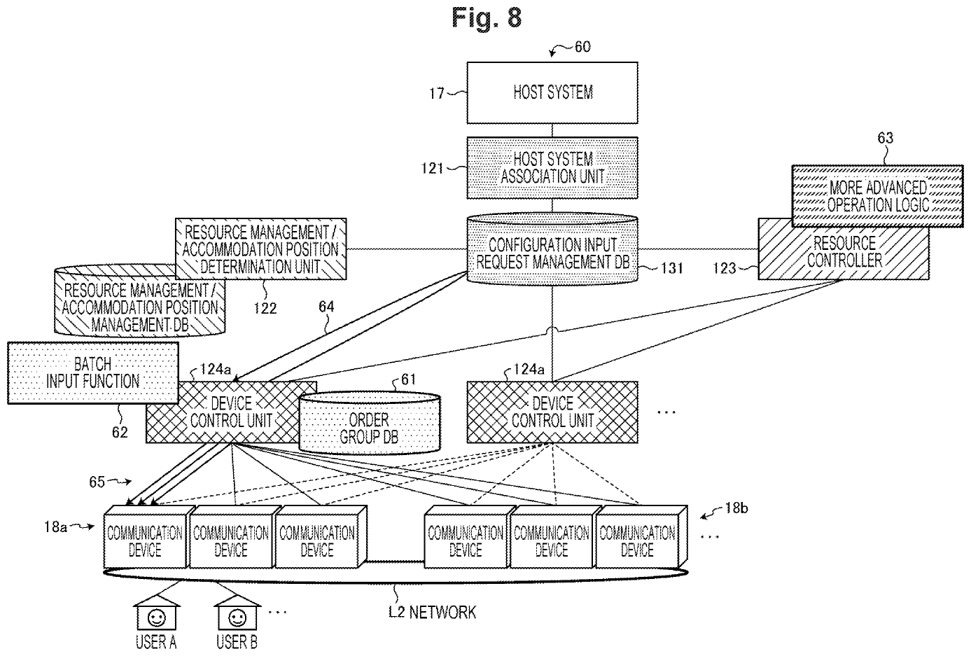

FIG. 8 indicates configuration input processing 60 which is an example of the configuration input processing according to the present disclosure. As indicated in FIG. 8, the device control unit 124 includes an order group DB 61 and a batch input function 62. The resource controller 123 includes more advanced operation logic 63.

The order group DB 61 and the batch input function 62 are used to solve the problems related to the exclusive control described above with reference to FIG. 4. The more advanced operation logic 63 is used to solve the problems related to the resource control described above with reference to FIG. 5.

### 4-1. Batch Input of Configurations

The device control unit 124 acquires a configuration input request from the management DB 131. When the device control unit 124 acquires the configuration input request, the device control unit 124 collectively acquires a plurality of configuration input requests to the same communication device 18 (64). The device control unit 124 stores the plurality of acquired configuration input requests in the order group DB 61 as an order group (request group) to the same communication device.

The order group DB 61 is implemented as a sub DB. The order group DB 61 is a DB in the device control unit 124 different from the management DB 131.

The order group DB 61 stores an order group to the same communication device. The order group is a plurality of orders (requests), and the plurality of orders (requests) correspond to a plurality of configurations.

The device control unit 124 includes the batch input function 62. The batch input function 62 relates to determination as to whether a plurality of configuration input requests conflict with other configuration input requests. Regarding the order group, the device control unit 124 determines whether a plurality of configurations can be simultaneously input to a specific communication device 18. This input determination means determination of a plurality of configuration input requests that do not conflict with each other.

For example, the device control unit 124 makes this input determination on the basis of information such as (1) whether the plurality of configurations are configurations of the same user or (2) whether a certain user has a configuration (that is, setting) common to other users.

The device control unit 124 specifies a plurality of configurations that can be simultaneously input to a specific communication device 18. The device control unit 124 inputs a plurality of specified configurations together into a specific communication device 18 (65).

As described above, the device control unit 124 determines a plurality of configuration input requests that do not conflict with each other and then collectively inputs a plurality of configurations corresponding to these configuration input requests to the specific communication device 18. This input processing can reduce processing load of activation processing for converting a configuration input request into a command.

Furthermore, the device control unit 124 performs processing for establishing a connection to the communication device 18. Input processing can also reduce overhead in a case where this establishment processing is slow.

As described above, the device control unit 124 collectively acquires a plurality of configuration input requests to the same communication device 18 from the management DB 131. A plurality of configurations are specified from the configuration input requests, and then the specified plurality of configurations are input to the specific communication device 18. Thereafter, the device control unit 124 collectively reflects configuration input results in the management DB 131.

In other words, the device control unit 124 reduces a frequency of access to the management DB 131 by distributing the DB itself (order group DB 61). This can reduce overhead of order (request) acquisition.

### 4-2. Resource Control to Avoid Expected Delay

The resource controller 123 includes more advanced operation logic 63. The resource controller 123 monitors not only reception states and processing speed of the configuration input requests but also types of the configuration input requests and the target communication device 18.

The resource controller 123 extracts configuration input requests for each communication device 18. The resource controller 123 can estimate an amount of commands to be input to the communication device 18 on the basis of the types of the configuration input requests. Thus, the resource controller 123 can estimate the amount of commands to be input to each communication device 18 and a completion time point of each configuration input request. The completion time point of a specific configuration input request can be calculated on the basis of the amount of commands input to the same communication device 18 before the configuration input request and an estimated execution period of each command.

In a case where delays of the configuration input requests are expected, the resource controller 123 accelerates configuration input processing by the following resource control. For example, in a case where the resource controller 123 detects a “configuration input request whose scheduled completion time point exceeds a processing deadline”, the resource controller 123 executes the following resource control. The resource control includes two cases.

The first case is a case where (1) the number of device control units 124×the number of communication devices 18 that can be simultaneously controlled by one device control unit 124≤the number of all device control units 124, and (2) the configuration input requests are distributed to all the device control units 124. In the first case, the resource controller 123 adds the device control unit 124.

The second case is a case where the configuration input requests are concentrated on the specific communication device 18. In the second case, the resource controller 123 fixes the device control unit 124 that controls the specific communication device 18 to one device control unit 124. The resource controller 123 changes setting of the device control unit 124 such that only this one device control unit 124 controls the specific communication device 18.

The resource controller 123 scales in extra device control units 124 by changing the setting of the device control unit 124. The resource controller 123 allocates floated resources to one device control unit 124. In a stage where the predicted order delay is canceled, the resource controller 123 returns the setting of the device control unit 124 to the original state.

### 5. FLOWCHART OF CONFIGURATION INPUT PROCESSING

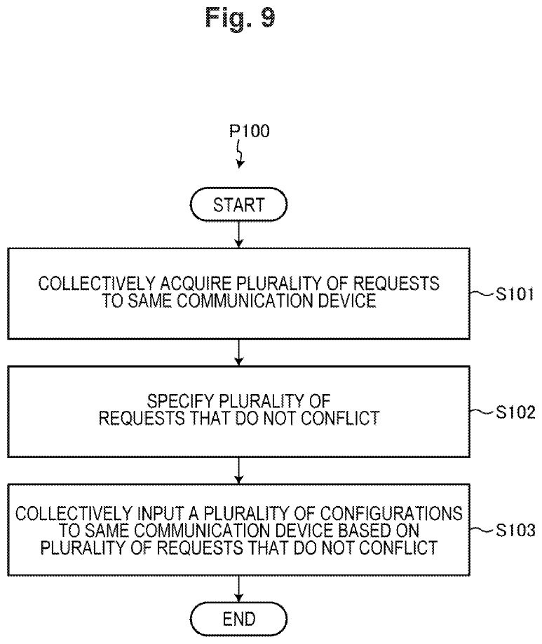

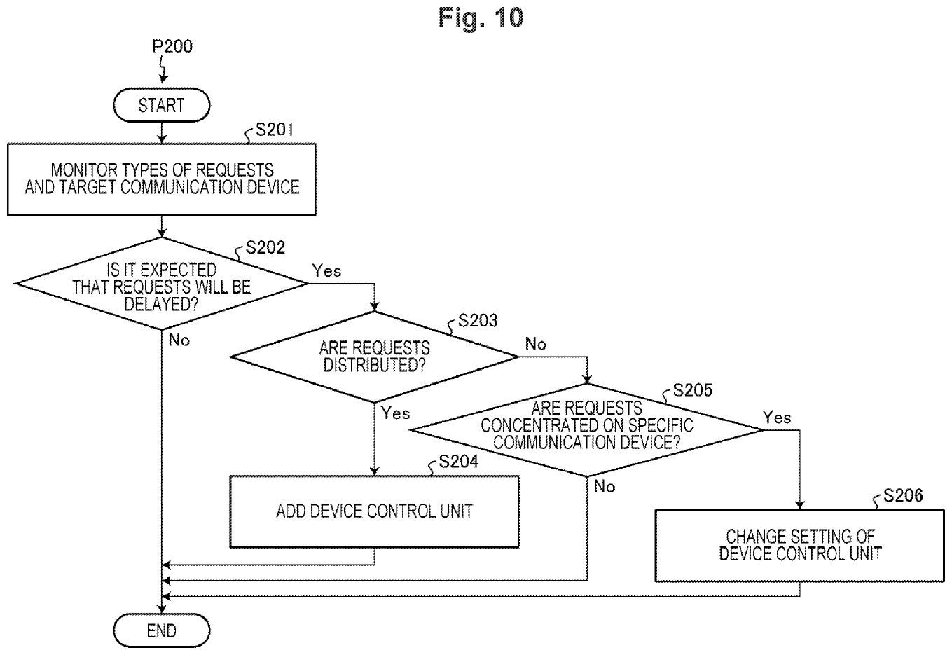

Next, a flowchart of an example of configuration input processing will be described with reference to FIGS. 9 and 10. Examples of the configuration input processing include the following two kinds of processing: (1) processing for inputting a configuration to a communication device; and (2) processing for establishing resource control for the communication device. These two kinds of processing are performed, for example, by the centralized management server 100 in FIG. 6.

FIG. 9 is a flowchart indicating processing P100 which is an example of the processing for inputting a configuration to a communication device.

The device control unit 124 of the centralized management server 100 collectively acquires a plurality of requests to the same communication device 18 (step S101).

The device control unit 124 specifies a plurality of requests that do not conflict among the acquired plurality of requests (step S102).

The device control unit 124 collectively inputs a plurality of specified configurations to the same communication device 18 on the basis of the plurality of requests that do not conflict (step S103).

FIG. 10 is a flowchart indicating processing P200 that is an example of the processing for establishing resource control for the communication device.

The resource controller 123 of the centralized management server 100 monitors types of the requests and the target communication device 18 (step S201).

The resource controller 123 determines whether it is expected that the requests will be delayed (step S202).

In a case where it is not expected that the requests will be delayed (step S202: No), the processing P200 ends.

In a case where it is expected that the requests will be delayed (step S202: Yes), the resource controller 123 determines whether the requests are distributed to a plurality of communication devices 18 (step S203).

In a case where the requests are distributed to the plurality of communication devices 18 (step S203: Yes), the resource controller 123 adds the device control unit 124 (step S204).

In a case where the requests are not distributed to the plurality of communication devices 18 (step S203: No), the resource controller 123 determines whether the requests are concentrated on the specific communication device 18 (step S205).

In a case where the requests are not concentrated on the specific communication device 18 (step S205: No), the processing P200 ends.

In a case where the requests are concentrated on the specific communication device 18 (step S205: Yes), the resource controller 123 changes setting of the device control unit 124 (step S206). Specifically, the resource controller 123 scales up resources to be allocated to this specific communication device.

### 6. EFFECTS

The centralized management server 100 can improve performance in processing of configuration input requests by the centralized management server 100 while securing normality of the communication device 18 to be controlled by exclusive control. In addition, the centralized management server 100 can flexibly control machine resources according to characteristics of the exclusive control and the configuration input requests. As a result, the centralized management server 100 can efficiently use resources and can process the configuration input requests without waste.

As described above, the device control unit 124 of the centralized management server 100 distributes content of the DB itself, making it unnecessary to go to a master DB (management DB 131) to acquire the content of the DB. This may reduce overhead for acquisition.

The device control unit 124 inputs a plurality of configurations together into the communication device 18. A functional unit of the centralized management server 100 can be implemented by using, for example, Ansible (registered trademark). Even in a case where overhead of Ansible activation is large and overhead of edge access is large, such configuration input can improve performance of order processing.

In addition, the device control unit 124 determines whether the plurality of configuration input requests do not conflict with each other. For example, this conflict determination is performed on the basis of information such as (1) whether the configuration input requests correspond to the same user or (2) whether the configuration input request of the user includes setting common to other users.

As described above, in a case where the following two situations are satisfied, the resource controller 123 of the centralized management server 100 scales out the device control unit 124: (1) the device control unit 124 is fully operated in a situation where “the number of device control units 124” ×“the number of communication devices 18 that can be simultaneously controlled by one device control unit 124”≤the number of all the device control units 124. (2) Configuration input requests have come to the communication device 18 other than the communication device 18 that is being controlled.

In a case where the configuration input requests are concentrated on the specific communication device 18, the resource controller 123 increases scale-up and resource allocation such as CPU/memory according to the processing period for each type of order. Regarding insufficient resources, the resource controller 123 scales in the excess device control unit 124 to secure the insufficient resources. The secured resources can improve speed of order processing.

### 7. HARDWARE CONFIGURATION

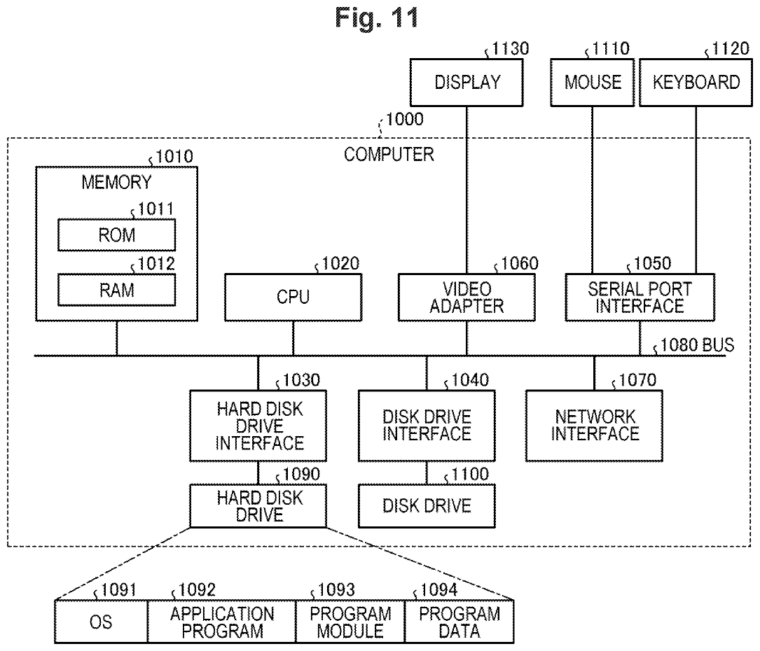

FIG. 11 is a view illustrating a computer 1000 which is an example of a hardware configuration of a computer. The system and methods described in this specification are implemented by, for example, the computer 1000.

The computer 1000 is an example of a computer that implements the centralized management server 100 by executing a program. The computer 1000 includes a memory 1010 and a CPU 1020. The computer 1000 also includes a hard disk drive interface 1030, a disk drive interface 1040, a serial port interface 1050, a video adapter 1060, and a network interface 1070. Those components are connected to each other via a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. A removable storage medium (for example, a magnetic disk or an optical disk) may be inserted into the disk drive 1100. The serial port interface 1050 is connected to, for example, a mouse 1110 and a keyboard 1120. The video adapter 1060 is connected to, for example, a display 1130.

The hard disk drive 1090 stores an OS 1091, an application program 1092, a program module 1093, and program data 1094. The program to be executed by the computer 1000 defines a plurality of kinds of operation of the centralized management server 100. This program can be implemented as the program module 1093 described in codes executable by the computer 1000. The program module 1093 is stored in the hard disk drive 1090, for example. For example, the hard disk drive 1090 stores the program module 1093 for executing processing similar to the functions of the components of the centralized management server 100. Note that the hard disk drive 1090 may be replaced with a solid state drive (SSD).

The hard disk drive 1090 can store a configuration input program for configuration input processing. The hard disk drive 1090 may store a computer program product including the configuration input program (a plurality of instructions). In a case where the configuration input program is executed, the configuration input program performs one or more methods as described above.

Setting data to be used for the various kinds of processing described above can be implemented as the program data 1094. The setting data is stored in, for example, the memory 1010 or the hard disk drive 1090. The CPU 1020 loads the program module 1093 and the program data 1094 stored in the memory 1010 or the hard disk drive 1090 to the RAM 1012 as necessary. The CPU 1020 performs the various kinds of processing described above.

Note that the program module 1093 and the program data 1094 may be stored in a removable storage medium instead of the hard disk drive 1090. The CPU 1020 may load the program module 1093 and the program data 1094 via the disk drive 1100, or the like. Alternatively, the program module 1093 and the program data 1094 may be stored in another computer connected to the computer 1000 via a network (LAN, WAN, or the like). In this case, the CPU 1020 may load the program module 1093 and the program data 1094 via the network interface 1070.

### 8. SUMMARY OF EMBODIMENTS

As described above, the centralized management server 100 includes the device control unit 124. In at least one embodiment, the device control unit 124 acquires a plurality of configuration input requests corresponding to a specific communication device. Thereafter, the device control unit 124 determines whether the plurality of configuration input requests conflict with other configuration input requests corresponding to the specific communication device. In a case where it is determined that the plurality of configuration input requests do not conflict with other configuration input requests, the device control unit 124 collectively inputs a plurality of configurations corresponding to the plurality of configuration input requests to the specific communication device.

In some embodiments, the device control unit 124 collectively acquires a plurality of configuration input requests corresponding to a specific communication device from a database that stores a plurality of configuration input requests corresponding to any of the plurality of communication devices.

In some embodiments, the device control unit 124 stores a plurality of configuration input requests acquired by the device control unit 124 in another database. Thereafter, the device control unit 124 acquires a plurality of configuration input requests corresponding to a specific communication device from the other database.

In some embodiments, the device control unit 124 collectively adds a plurality of results of inputting a plurality of configurations to the database.

As described above, the centralized management server 100 includes the resource controller 123. In at least one embodiment, the resource controller 123 determines whether a plurality of configuration input requests corresponding to any of a plurality of communication devices are distributed to the plurality of communication devices. In a case where it is determined that the plurality of configuration input requests corresponding to any of the plurality of communication devices are distributed to the plurality of communication devices, the resource controller 123 scales out a plurality of resources allocated to the plurality of communication devices.

In some embodiments, the resource controller 123 determines whether the plurality of configuration input requests corresponding to any of the plurality of communication devices are concentrated on one of the plurality of communication devices. In a case where it is determined that the plurality of configuration input requests corresponding to any of the plurality of communication devices are concentrated on one of the communication devices, the resource controller 123 scales up resources to be allocated to the one of the communication devices.

### 9. SUPPLEMENTS

Finally, the above description is supplemented by other embodiments. Various embodiments have been described above with reference to the drawings. These embodiments are exemplary and the above description is not intended to limit the present disclosure to these embodiments. The features described in this specification may be implemented in various ways, including variations and improvements based on the knowledge of those skilled in the art.

### (Various Modifications)

In this specification, some kinds of processing are described as processing to be performed automatically. Some of these kinds of processing may be performed manually. Some other kinds of processing have been described as processing to be performed manually. All or some of these other kinds of processing may be performed automatically by using known methods.

Various implementations of the centralized management server 100 are described herein or illustrated in the drawings. Some implementations relate to information including various kinds of data, data processing procedure, specific names, or parameters. Such implementations may be changed in any manner unless otherwise stated. For example, the various kinds of data are not limited to the data illustrated in the drawings.

The components of the system are illustrated in the drawings. The illustrated components conceptually illustrate functions of the device. The components are not necessarily physically constituted as illustrated in the drawings. The components may be integrated or distributed, and a specific form of the device is not limited to the illustrated form. The whole or part of the device may be functionally or physically integrated or distributed depending on various loads and usage conditions.

### (Terms Representing Components)

Terms (module, section, -er suffix, or -or suffix) can be replaced with a unit, means, a circuit, or the like. For example, a communication module, a control module, and a storage module may be replaced with a communication unit, a control unit, and a storage unit, respectively.

### (Configuration of Control Unit)

The configuration of the control unit 120 illustrated in FIG. 7 is exemplary, and the data processing described for a specific unit does not necessarily need to be performed by the specific unit. For example, the resource controller 123 may perform the data processing described for the device control unit 124. The control unit 120 may include other units not illustrated in FIG. 7. The other units may perform the data processing described for the control unit 120.

### (Data Processing Device)

The data processing device described for the control unit 120 is not limited to the specific hardware described above. The data processing device may be, for example, various computers or integrated circuits such as an application specific integrated circuit (ASIC), a field programmable gate array (FPGA), and a general purpose graphic processing unit (GPGPU).

### REFERENCE SIGNS LIST

1 Environment
17 Host system
18 Communication device
100 Centralized management server
110 Communication unit
120 Control unit
121 Association unit
122 Determination unit
123 Resource controller
124 Device control unit
130 Storage unit
131 Management DB
200 Network

1. A configuration input device comprising:
an acquisition unit that acquires a plurality of configuration input requests corresponding to a specific communication device;
a conflict determination unit that determines whether the plurality of configuration input requests conflict with other configuration input requests corresponding to the specific communication device; and
an inputting unit that collectively inputs a plurality of configurations corresponding to the plurality of configuration input requests to the specific communication device in a case where it is determined that the plurality of configuration input requests do not conflict with the other configuration input requests.

2. The configuration input device according to claim 1,
wherein the acquisition unit collectively acquires the plurality of configuration input requests corresponding to the specific communication device from a database that stores a plurality of configuration input requests corresponding to any of the plurality of communication devices.

3. The configuration input device according to claim 2, further comprising:
a storing unit that stores the plurality of configuration input requests acquired by the acquisition unit in another database,
wherein the conflict determination unit acquires the plurality of configuration input requests corresponding to the specific communication device from the another database.

4. The configuration input device according to claim 2, further comprising:
an addition unit that collectively adds a plurality of results of inputting the plurality of configurations to the database.

5. The configuration input device according to claim 2, further comprising:
a distribution determination unit that determines whether the plurality of configuration input requests corresponding to any of the plurality of communication devices are distributed to the plurality of communication devices; and
a scale-out unit that performs scale-out of a plurality of resources to be allocated to the plurality of communication devices in a case where it is determined that the plurality of configuration input requests corresponding to any of the plurality of communication devices are distributed to the plurality of communication devices.

6. The configuration input device according to claim 2, further comprising:
a concentration determination unit that determines whether the plurality of configuration input requests corresponding to any of the plurality of communication devices are concentrated on one of the plurality of communication devices; and
a scale-up unit that performs scale-up of resources to be allocated to the one of the communication devices in a case where it is determined that the plurality of configuration input requests corresponding to any of the plurality of communication devices are concentrated on the one of the communication devices.

7. A configuration input method to be executed by a computer, the configuration input method comprising:
acquiring a plurality of configuration input requests corresponding to a specific communication device;
determining whether the plurality of configuration input requests conflict with other configuration input requests corresponding to the specific communication device; and
collectively inputting a plurality of configurations corresponding to the plurality of configuration input requests to the specific communication device in a case where it is determined that the plurality of configuration input requests do not conflict with the another configuration input requests.

8. (canceled)

9. The configuration input method according to claim 7,
the plurality of configuration input requests corresponding to the specific communication device is collectively acquired from a database that stores a plurality of configuration input requests corresponding to any of the plurality of communication devices.

10. The configuration input method according to claim 9, further comprising:
the plurality of configuration input requests acquired by the acquisition unit is stored in another database,
wherein the plurality of configuration input requests corresponding to the specific communication device is acquired from the another database.

11. The configuration input method according to claim 9, further comprising:
a plurality of results of inputting the plurality of configurations is collectively added to the database.

12. The configuration input method according to claim 9, further comprising:
determining whether the plurality of configuration input requests corresponding to any of the plurality of communication devices are distributed to the plurality of communication devices; and
performing scale-out of a plurality of resources to be allocated to the plurality of communication devices in a case where it is determined that the plurality of configuration input requests corresponding to any of the plurality of communication devices are distributed to the plurality of communication devices.

13. The configuration input method according to claim 9, further comprising:
determining whether the plurality of configuration input requests corresponding to any of the plurality of communication devices are concentrated on one of the plurality of communication devices; and
performing scale-up of resources to be allocated to the one of the communication devices in a case where it is determined that the plurality of configuration input requests corresponding to any of the plurality of communication devices are concentrated on the one of the communication devices.

14. A computer-readable non-transitory recording medium storing computer-executable program instructions that when executed by a processor cause a computer to execute a configuration input method comprising:
acquiring a plurality of configuration input requests corresponding to a specific communication device;
determining whether the plurality of configuration input requests conflict with other configuration input requests corresponding to the specific communication device; and
collectively inputting a plurality of configurations corresponding to the plurality of configuration input requests to the specific communication device in a case where it is determined that the plurality of configuration input requests do not conflict with the another configuration input requests.

15. The computer-readable non-transitory recording medium according to claim 14 wherein the configuration input method further comprises:
wherein the plurality of configuration input requests corresponding to the specific communication device is collectively acquired from a database that stores a plurality of configuration input requests corresponding to any of the plurality of communication devices.

16. The computer-readable non-transitory recording medium according to claim 15 wherein the configuration input method further comprises:
wherein the plurality of configuration input requests acquired by the acquisition unit is stored in another database,
wherein the plurality of configuration input requests corresponding to the specific communication device is acquired from the another database.

17. The computer-readable non-transitory recording medium according to claim 15 wherein the configuration input method further comprises:
wherein a plurality of results of inputting the plurality of configurations is collectively added to the database.

18. The computer-readable non-transitory recording medium according to claim 15 wherein the configuration input method further comprises:
determining whether the plurality of configuration input requests corresponding to any of the plurality of communication devices are distributed to the plurality of communication devices; and
performing scale-out of a plurality of resources to be allocated to the plurality of communication devices in a case where it is determined that the plurality of configuration input requests corresponding to any of the plurality of communication devices are distributed to the plurality of communication devices.

19. The computer-readable non-transitory recording medium according to claim 15 wherein the configuration input method further comprises:
determining whether the plurality of configuration input requests corresponding to any of the plurality of communication devices are concentrated on one of the plurality of communication devices; and
performing scale-up of resources to be allocated to the one of the communication devices in a case where it is determined that the plurality of configuration input requests corresponding to any of the plurality of communication devices are concentrated on the one of the communication devices.

20. The configuration input device according to claim 1,
wherein if a delay to the plurality of configuration input requests is detected, a resource controller adds an additional device control unit for a case in which a number of device control units times a number of communication devices that are simultaneously controlled is less than a total number of device control units and the plurality of configuration input requests is distributed among all device controls units.

21. The configuration input device according to claim 20,
wherein if a delay to the plurality of configuration input requests is detected, the resource controller fixes the device control unit that controls the specific communication device to one device control unit for a case in which the configuration input requests are concentrated on the specific communication device.
